(19) United States
(12) Patent Application Publication
(10) Pub. No.: US 2011/0027430 A1
(43) Pub. Date: Feb. 3, 2011

(54) Lollipop Apparatus and Method

(75) Inventor: Steve Davidovici, Las Vegas, NV (US)

Correspondence Address: PROCOPIO, CORY, HARGREAVES & SAVITCH LLP, 525 B STREET, SUITE 2200, SAN DIEGO, CA, 92101, US

(73) Assignee: SUGAR FACTORY, LLC, Las Vegas, NV (US)

(21) Appl. No.: 12/922,659

(22) PCT Filed: Feb. 11, 2009
(86) PCT No.: PCT/US09/33762

§ 371 Date: Sep. 14, 2010

Related U.S. Application Data
(63) Continuation-in-part of application No. 12/262,507, filed on Oct. 31, 2008.

(51) Int. Cl. A23G 3/56

(52) U.S. Cl. 426/134; 428/99; 426/421

(57) ABSTRACT

A lollipop ball is formed to a lollipop ball engagement mechanism and the lollipop ball engagement mechanism extends outward from the lollipop ball to releasably engage a proximal end of a lollipop stick. Alternatively, a lollipop ball is formed to a lollipop ball engagement mechanism that defines a cavity inside the sphere of the lollipop ball and the proximal end of the lollipop stick releasably engages the cavity located in the interior of the lollipop. Alternatively, the lollipop itself can be formed to define the cavity such that no lollipop ball engagement mechanism is required to releasably engage the proximal end of the lollipop stick. The lollipop stick can also include one or more design elements.

### BACKGROUND

1. Field of the Invention

The present invention generally relates to lollipops and the manufacturing of lollipops.

2. Related Art

Conventional candy products such as lollipops have broad appeal to consumers. However, conventional candy products are typically consumed while the wrapping and other accoutrements are discarded. For example, the wrapper and stick of a lollipop is discarded after the lollipop is consumed. Additionally, conventional candy products suffer from a lack of association with high fashion and desirable personal accessories. Therefore, what is needed is a new lollipop that includes re-usable components and has desirable fashion and personal accessory elements.

### SUMMARY

Accordingly, described herein is a consumable apparatus that includes candy or other edible material (referred to herein as a “lollipop”) mounted on an elongated handle (referred to herein as a “stick”). In a first embodiment, the lollipop is formed to a threaded mount and the threaded mount is configured to releasably engage a threaded cavity on the stick. In a second embodiment, the lollipop is formed to a threaded insert that defines a threaded cavity and the stick has a proximal end with threads that are configured to releasably engage the threaded cavity within the lollipop. Alternatively, the lollipop itself can be formed to define the threaded cavity such that no threaded insert is required to releasably engage the threaded stick. Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a block diagram illustrating a threaded lollipop with decorative stick according to an embodiment of the present invention;

FIG. 2 is a block diagram illustrating a threaded lollipop according to an embodiment of the present invention;

FIG. 3 is a block diagram illustrating a hinged container for a threaded lollipop according to an embodiment of the present invention;

FIG. 4 is a block diagram illustrating a two piece container for a threaded lollipop according to an embodiment of the present invention;

FIGS. 5A-5D are block diagrams illustrating an example alternative engagement mechanism for securing a lollipop ball to a lollipop stick according to an embodiment of the present invention; and

FIG. 6 is a flow diagram illustrating an example process for using a lollipop according to an embodiment of the present invention.

### DETAILED DESCRIPTION

Certain embodiments as disclosed herein provide for a threaded lollipop that includes a reusable stick that screws into a threaded cavity within the lollipop or into a threaded cavity defined by an insert about which the lollipop is formed. An alternative embodiment provides for a threaded mount about which the lollipop is formed where the threaded mount extends out from the lollipop and screws into a threaded cavity in the stick. A cap is also provided with an optional hole for use with a lollipop ball alone or for use with a lollipop ball that is engaged with a lollipop stick.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

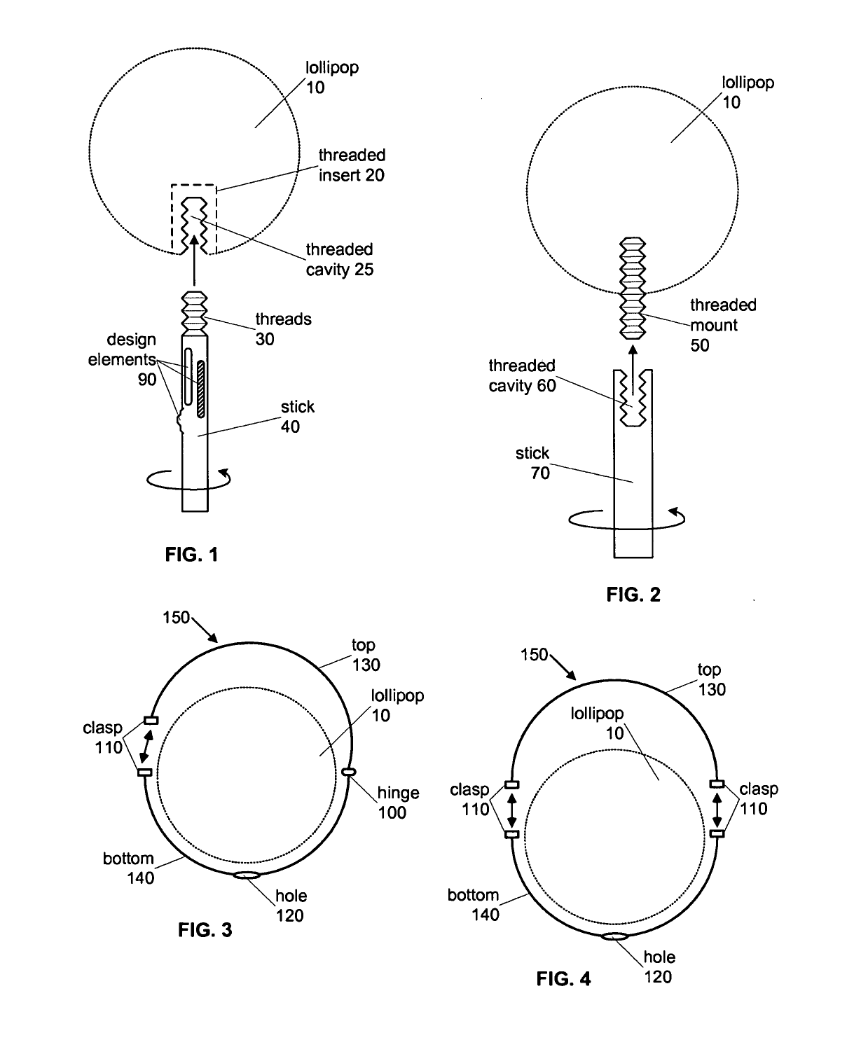

FIG. 1 is a block diagram illustrating a threaded lollipop 10 with decorative stick 40 according to an embodiment of the present invention. In the illustrated embodiment, the lollipop 10 ball is formed around a threaded insert 20 during manufacture of the lollipop 10 ball. The threaded insert 20 is one embodiment of an engagement mechanism for the lollipop. In one embodiment, the lollipop 10 ball is a thirty two (32) gram ball.

The threaded insert 20 can be made of plastic or paper or any other material capable of defining a threaded cavity 25. In one embodiment, the threaded insert 20 is made from an edible material. The function of the threaded insert 20 is twofold. First, the insert defines a base upon which the lollipop 10 ball is formed. In one embodiment, the end of the threaded insert 20 that is near the perimeter edge of the lollipop 10 ball is substantially flush or slightly recessed into the interior of the lollipop 10 ball. In this fashion the surface of the lollipop 10 ball is primarily spherical with a recess where the threaded cavity 25 is located.

In an alternative embodiment, the threaded cavity 25 may be defined by the lollipop 10 ball itself. In such an embodiment, when the lollipop 10 ball is formed, the threaded cavity 25 is defined such that the lollipop 10 ball hardens and the threaded cavity 25 remains.

The threaded cavity 25 is sized and shaped to snugly receive threads 30 that are provided on one end of the lollipop) stick 40. The threads 30 of the stick 40 are twisted into the threaded cavity 25 defined in the lollipop 10 ball in order to releasably secure the lollipop 10 ball to the stick 40.

The stick 40 may also be decorated with design elements 90 to add to the overall appeal of the lollipop 10 and the stick 40. The design elements 90 on the stick 40 may include various prints, designs, wraps, and attachments. In one embodiment, the stick 40 is bejeweled with 2 mm to 5 mm crystals that are affixed to the outer surface of the stick. The crystals can advantageously be different colors in order to provide the desired look for the lollipop stick 40. Customizable sticks may also be made available to consumers via a custom order interface, e.g., via an operator on a telephone or via a website.

FIG. 2 is a block diagram illustrating a threaded lollipop 10 according to an embodiment of the present invention. In the illustrated embodiment, the lollipop 10 ball is formed around a threaded mount 20 during manufacture of the lollipop 10 ball. The threaded mount 20 extends into the interior of the lollipop 10 ball and also extends beyond the exterior surface of the lollipop 10 ball. The portion of the threaded mount 50 that extends beyond the exterior surface of the lollipop ball 10 (i.e., the exterior portion) is threaded. The exterior portion may also be designed to use an alternative engagement mechanism such as the fork and barb previously described with respect to FIG. 1.

The portion of the threaded mount 50 that extends into the interior of the lollipop ball 10 (i.e., the interior portion) may or may not be threaded. The interior portion is preferably optimally shaped to provide a secure mount upon which the lollipop 10 ball may be formed during manufacture of the lollipop 10 ball.

The exterior portion of the threaded mount 20 is sized and shaped to snugly fit into the threaded cavity 60 that is defined by one end of the lollipop stick 70. When the threaded mount 20 is snugly fit into the threaded cavity 60, the lollipop 10 ball is releasably secured to the stick 70. As previously described, the means for engaging/securing the lollipop 10 ball to the stick 70 may include threads, forks and barbs, or alternative means as will be understood by those skilled in the art. In the illustrated embodiment, the threaded mount 50 is twisted into the threaded cavity 60 that is defined in one end of the lollipop stick 70 in order to releasably secure the lollipop 10 ball to the stick 70. Although not shown, stick 70 may also include design elements 90 as previously described with respect to FIG. 1.

FIG. 3 is a block diagram illustrating a hinged container 150 for a threaded lollipop according to an embodiment of the present invention. In the illustrated embodiment, the container 150 includes a top 130 portion and a bottom 140 portion that are pivotably connected by a hinge 100. The container 150 surrounds a lollipop 10 ball and is configured to securely close by a clasp 110 means. When closed, the container 150 defines a spherical compartment in which the lollipop 10 ball can be stored. In one embodiment, an optional hole 120 is provided in a portion of the surface of the container 150 so that the lollipop stick 40 may pass through the hole 120 or so that the threaded mount 50 may pass through the hole 120.

FIG. 4 is a block diagram illustrating a two piece container 150 for a threaded lollipop according to an embodiment of the present invention. In the illustrated embodiment, the container 150 includes a top 130 portion and a separate bottom 140 portion that together define a spherical compartment in which the lollipop 10 ball can be stored. The top 130 portion and bottom 140 portion are each configured with one or more matching clasps 110 that engage to securely hold the top 130 portion to the bottom 140 portion to define the spherical compartment. In one embodiment, an optional hole 120 is provided in a portion of the surface of the container 150 so that the lollipop stick 40 may pass through the hole 120 or so that the threaded mount 50 may pass through the hole 120.

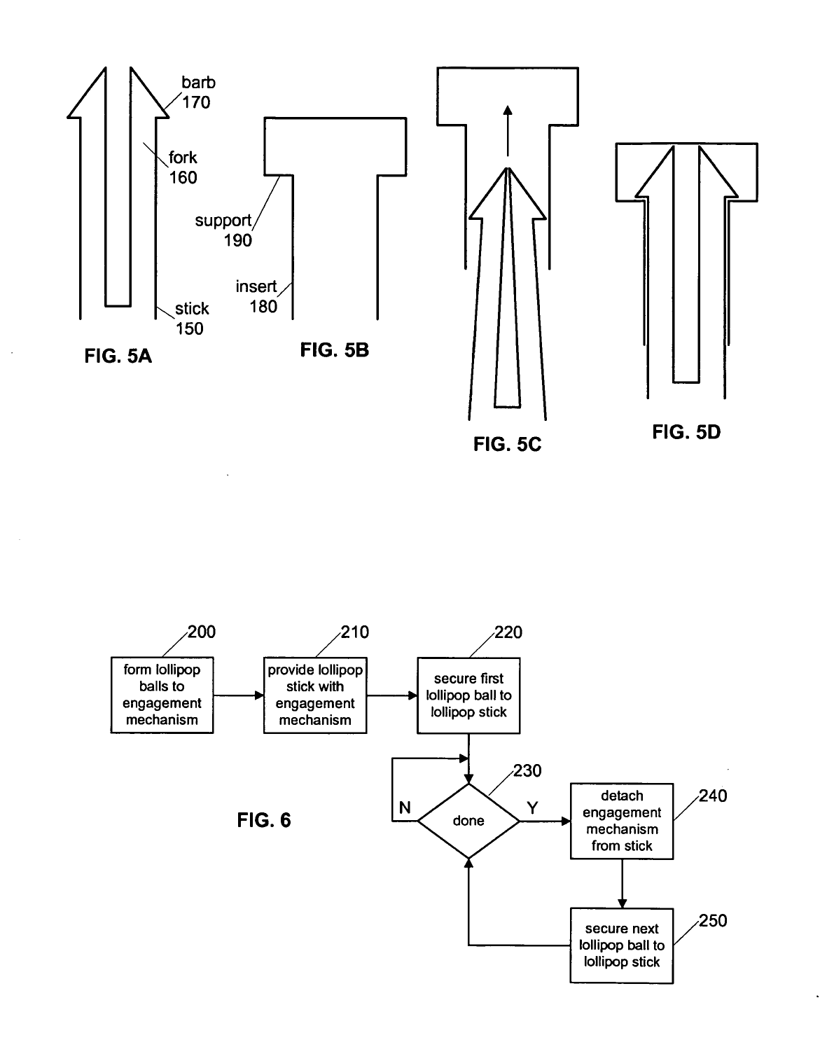

FIGS. 5A-5D are block diagrams illustrating an example alternative engagement mechanism for releasably securing a lollipop ball to a lollipop stick according to an embodiment of the present invention. In the illustrated embodiment, a lollipop stick 150 is provided that has two or more forks 160 and each fork 160 has a barb 170 at its end. A corresponding insert 180 is also provided that includes a support 190. The stick 150 is releasably secured to the insert 180 by compressing the two or more forks 160 together and sliding the forks 160 into the insert 180. When the forks 160 are released, the barbs 170 engage the supports 190 to secure the lollipop ball (not shown) to the lollipop stick 150. The lollipop stick 150 may be detached from the insert 180 by compressing the two or more forks 160 and pulling the stick away from the insert 180. An advantage of this type of engagement mechanism is that it allows the lollipop ball to freely rotate about the lollipop stick 150 while remaining securely fastened to the lollipop stick 150.

FIG. 6 is a flow diagram illustrating an example process for using a lollipop according to an embodiment of the present invention. The steps in the illustrated method can be performed in the order shown or in an alternative order. Initially, in step 200 one ore more lollipop balls are formed about an engagement mechanism. The engagement mechanism can be a female threaded cavity or a male threaded mount. The engagement mechanism may also be support platforms for receiving corresponding barbs on the lollipop stick.

Next, in step 210 the lollipop stick is provided with a corresponding engagement mechanism. The engagement mechanism can be a female threaded cavity or male threads. The engagement mechanism may also be two or more forks with barbs such that the forks can be compressed together to slide into an insert where the barbs can engage the support platforms. The lollipop stick can also be decorated by wrapping the stick in a printed material, by printing directly onto the stick, by affixing items such as decorative crystals, jewels, and the like to the stick.

Once the corresponding engagement mechanisms are in place, in step 220 the engagement mechanism of a first lollipop ball is releasably secured to the lollipop stick. This may be accomplished by screwing the lollipop stick into the engagement mechanism of the first lollipop ball, or by compressing the lollipop stick and sliding it into the engagement mechanism of the first lollipop ball. Once the lollipop ball is consumed or is otherwise done, as determined in step 230, the engagement mechanism and the lollipop stick are detached in step 240. Then, in step 250 the engagement mechanism of a next lollipop ball is secured to the lollipop stick and the process continues with as many additional lollipop balls as desired.

A significant advantage of the described lollipop ball with engagement mechanism and corresponding lollipop stick with engagement mechanism is that the lollipop stick can be reused by a consumer. Furthermore, the reusability of the lollipop stick causes the lollipop stick to become a fashion accessory that can be attractively decorated. Another significant advantage of the reusable nature of the described lollipop ball with engagement mechanism and corresponding lollipop stick with engagement mechanism is the reduction in litter and paper product consumption that is associated with conventional lollipops that require single use discardable sticks.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

1.-19. (canceled)

20. A method of using a lollipop, comprising:
releasably securing a first lollipop head formed about a first lollipop head engagement mechanism to a mating engagement mechanism at a proximal end of a lollipop stick to create a first lollipop;
detaching the first lollipop head engagement mechanism from the mating engagement mechanism on the lollipop stick; and
releasably securing a second lollipop head formed about a second lollipop head engagement mechanism to the mating engagement mechanism on said lollipop stick to create a second lollipop.

21.-32. (canceled)

33. A method for using a lollipop, comprising:
providing a lollipop ball engagement mechanism having an exterior surface for engaging a lollipop ball, the lollipop ball engagement mechanism also having an interior surface;
forming a lollipop ball about the lollipop ball engagement mechanism;
providing a lollipop stick having a proximal end and a distal end, wherein the proximal end is shaped to releasably engage the lollipop ball engagement mechanism to create the lollipop.

34. The method of claim 33, wherein the shape of the proximal end of the lollipop stick includes a threaded section.
